(19) United States
(12) Patent Application Publication
(10) Pub. No.: US 2022/0342992 A1
(43) Pub. Date: Oct. 27, 2022

(54) AUTHORISING COMPONENT UPDATES

(71) Applicant: Hewlett-Packard Development Company, L.P., Spring, TX (US)

(72) Inventors: Joshua Serratelli Schiffman, Washington, DC (US); Carey Huscroft, Bristol (GB); Pierre Belgarric, Bristol (GB)

(73) Assignee: Hewlett-Packard Development Company, L.P., Spring, TX (US)

(21) Appl. No.: 17/761,691

(22) PCT Filed: Oct. 28, 2019
(86) PCT No.: PCT/US2019/058282

§ 371 Date: Mar. 18, 2022

(51) Int. Cl. G06F 21/57; G06F 21/53; G06F 21/30

(52) U.S. Cl. CPC G06F 21/57; G06F 21/53; G06F 21/305

(57) ABSTRACT

The present disclosure relates to methods, devices, and computer-readable media. In an example there is disclosed a method comprising detecting a state of a computing device, the computing device comprising at least one component. The method may further comprise comparing the detected state with a certified state of the device, the certified state indicating an expected state of the device as certified by a trusted authority. The method may further comprise, in response to the detected state and the certified state being different, identifying a component as a source of the difference and checking, by the trusted authority, whether the component is legitimate or not. The method may further still comprise, in response to the component being legitimate, certifying the difference and updating the certified state.

### BACKGROUND

Electronic devices, such as consumer electronics may be described as platforms or devices and may for example include hardware, software, and data. Such platforms may include components such as a hard drive, CPU, RAM, HID devices, BIOS, and configurable settings like serial numbers. Similar devices, such as two PCs may have the same type of hardware, but a different firmware version and serial number.

### BRIEF DESCRIPTION OF DRAWINGS

Examples will now be described, by way of non-limiting examples, with reference to the accompanying drawings, in which:

FIG. 1 is a flowchart of a method according to some examples;

FIG. 2 is a flowchart of a further method according to some examples; and

FIG. 3 is a simplified schematic of a device according to some examples.

### DETAILED DESCRIPTION

During the lifecycle of a device, platform or product, there may be a number of legitimate changes to the components therein, such as intentional modifications by the owner, authorized updates by IT providers, or unavoidable changes due to failure or degradation.

In some circumstances, these changes may be considered faults/malicious changes/rogue components/attacks and may raise alerts. Accepting the changes and updating a new edition or state of the platform may necessitate full recertification of a platform manifest to allow the platform to continue functioning as normal, which may be infeasible for some devices. For example, certification may be done in a factory or as part of the manufacturing process where checks can be made for the presence of legitimate components. Once a component has left the factory, recertification of the platform becomes more difficult. In some examples, a legitimate component may no longer be deemed legitimate if tampering is detected. In other words, an original component installed during manufacture and certified as legitimate may at some point be tampered with and, depending on the extend of the tampering, may not be a legitimate component anymore in that it may not function as the original, legitimate component or may no longer have the same trust or security rating.

Examples of platforms may include electronic products or consumer electronics. In some examples, a platform is a computing device consisting of hardware, software, and data. These components affect the behaviour of the device and thus a device may be characterised by their presence or absence. Each component may display behaviour which is characteristic of that specific component. For example, a memory may behave like a memory, a CPU like a CPU, etc.

In order to improve detection of such changes, in some examples methods of characterizing devices at different levels of granularity may be provided. In accordance with some examples, a device may collect measurements or other data relating to components of the platform. Components may be individually characterised via values, uniquely associated with the components, and/or behavioural patterns. For example, each hardware component may have a serial number and/or manufacturer ID. Software may have version numbers. Other components may demonstrate characteristic behaviours, such as a USB mass storage device which may be expected to act like one by following expected requests.

A change in a component may be detected when the characteristics or behavioural patterns change unexpectedly. A state of a component or a device comprising at least one component may give an indication of the characteristics, behaviours, version numbers, etc. of the current device or component(s). Behavioural patterns may include performance and energy usage, inputs and outputs from the component and their format including the response time.

In accordance with some examples, a method is provided for capturing or detecting the components (both software and hardware) on a platform (device) and enabling an authority like the original equipment manufacturer (OEM) to certify a “manifest” detailing the components. This manifest could be used by a trusted component or authority on the platform to check for deviations to detect failures, malicious modifications, or other issues.

In addition, changes to the platform may be either acceptable or unacceptable to a certifying party based on a defined policy. Determining whether the change is acceptable may specify additional information or checks to be performed on the device to make this decision. For example, a policy may define a specific manufacturer and part number or may specify that a component is replaced with a superior component (in terms of processing speed, power usage, capacity, etc. for example). In some examples, a policy may specify a certain level of trust, performance or security for the component.

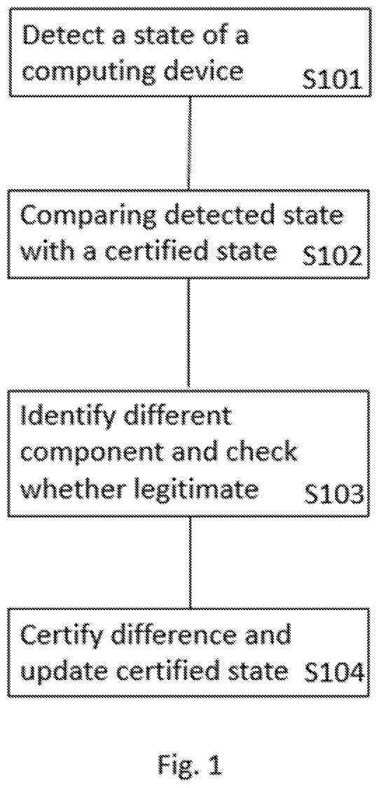

In some examples, there is provided a method as shown in FIG. 1. The method may comprise detecting, monitoring or capturing S101 a state of a computing device. The computing device may comprise at least one component. The method may further comprise comparing S102 the state, detected by the detecting, with a certified state of the device. The certified state may indicate an expected state of the device as certified by a trusted authority. In response to the detected state and the certified state being different, the method may further comprise identifying S103 a component as a source of the difference. The method may further comprise checking, by the trusted authority, whether the component is legitimate or not. Further, the method may comprise, in response to the component being legitimate, certifying S104 the difference and updating the certified state.

Detecting may be done by scanning the computing device and its systems/components or by running a self-diagnostic. The computing device may be any computer, such as a laptop, desktop, tablet, mobile phone or otherwise. A certified state of a device may be a report, list or manifest of the components within the device, including at least one of version numbers, characteristic and behavioural data, created when a trusted authority analyses the state of a device and certifies that the components are as expected, i.e. legitimate, performing to an expected standard and/or performing the tasks expected.

The trusted authority may be any authority with a correct level of assigned trust. The trusted authority may for example be associated with the OEM or may be an independent party authorised to detect and certify performance, security or trust standards for devices within a system. The trusted authority may carry out any or all of the method described above and may carry out the method at random or at predetermined times. If tampering with the computing device is suspected, the trusted authority may execute the above method autonomously to quickly identify potential issues and take appropriate action in response.

The trusted authority may be responsible for securely gathering information that describes the components of the device. The trusted authority may further securely store information indicating the certified state of the device. The stored information may represent a list or similar of the expected components which are part of or included in the device. The trusted authority may upon request, or at a predetermined time, certify the state of a device. This may include capturing or identifying some or all components in a device, comparing those components against a database of acceptable components and, if the components correspond to acceptable components in the database, certifying the state of the device as legitimate. The database may be maintained by the trusted authority or by the OEM or another authority.

A detected state and a certified state may be deemed to be different if, based on the comparison, the corresponding data collected for each state does not match. This comparison may not be an exact matching and can have a degree of compliance to some acceptable characteristics. For example, component identification numbers may be specified so as to be an exact match, but performance measurement may vary slightly to take age of the component into account. Further, the comparison may provide more granular information about the state so as to be able to provide additional context to help with a more subtle decision process, allowing for a more informed comparison between the detected state and the certified state.

In accordance with some examples, the difference may be certified or the changed component may be certified in isolation, rather than having to certify or recertify the whole computing device. Thus, devices in which components are updated or changed may still maintain a level of certification following the change, rather than losing the certification. In practical terms, this may be useful for ensuring manufacturer warranties for consumer electronic devices or may provide networks with a level of assurance that a device can perform to a specified standard, without the device needing to be physically returned to the factory or original certifying authority. Certifying a component or a change may include authorising certain rights or abilities to the component or may involve issuing a certificate that is accessible to other components in communication with the component and reflects the certification.

If a component is modified, the trusted authority may identify the modified component during a regular scan (detection and comparison sequence). In some examples, if a component is changed, it may report itself to the trusted authority to ask for certification and an update to the certified state.

In response to the detected state and the certified state not being different (being the same), recertifying is deemed not appropriate. In some examples, minor variations in the state, which are not considered significant enough to constitute a change (such as a performance reduction below a predetermined threshold, which may be expected as a component ages, for example) may be taken into account for the next scan of the device. In response to a component being deemed to be not legitimate, a number of actions may be taken, such as at least one of isolating the component from the rest of the device, isolating the device as a whole, notifying a relevant party and restarting the device. In some examples, the component may be allowed to continue to operate, but may have a security or trust rating lowered. In this example, a new certification of the change may be provided with an indication that the changes are accepted as legitimate, yet may not be deemed to be as trustworthy as with a factory certification.

In some examples, the certified state may include a device component list indicating the at least one component and a profile relating to the at least one component.

A device component list may list existing components in a device that have been previously certified as being legitimate, genuine, or meeting a predefined standard. If a component within a device has not been certified, it may be omitted from the device component list, may be marked or flagged as suspicious or may be isolated from the rest of the device.

The device component list may be updated to take into account the changes that a device will undergo during its lifetime, such as the changes described above. A change may be a modification, an addition or a removal of a component. Following a change the device component list may undergo an incremental certification in that the device component list will be updated or extended to include entries reflecting the change. This avoids the need for full recertification of the device component list. This, in turn, reduces the chance of unchanged parts of the device component list being tampered with. In some examples, certification of changes may be performed with varying assumptions about the changes. For example, a change could be accepted but a partial update of a device component list may be considered less trustworthy than an original factory certification. In this example, the new certification of the change may provide an indication that the changes are accepted as legitimate, yet may not be deemed to be as trustworthy as with a factory certification.

In some examples, after at least one change certification has been issued, a device may be issued a full recertification, for example by the original factory or other safe environment. In this way, a component may be temporarily recertified following a change and undergo a further full recertification subsequently. In some examples, a change certification may be applied for a specific amount of time and may expire once that amount of time has elapsed. This may give enough time for the user to bring/send the device to a location or environment that allows full recertification (or further analysis, potentially leading to no need for full recertification).

In some examples, the profile may include data relating to operation parameters, boot time, run time and/or power usage of the component.

The profile may include expected characteristic data for each component, which may be used to identify a component, identify when the component has been replaced and identify how (in terms of functionality) the component has been changed. Further, in some examples, having more than one metric on the basis of which to compare values may improve the quality of the profile and therefore the difficulty for a non-legitimate component to continue operating undetected.

In some examples, the profile may be created by the trusted authority based on a measured or detected characteristic of the component.

The trusted authority may both create the profile against which a component is compared when being certified and certify the component. Having the same trusted authority for both actions may improve consistency of the measurements and the trust levels given to components. Components generally may be given a trust rating based on many factors including their age, manufacturer, processing ability and/or various policies. Components may also be rated on trust based on the environments in which they are used and/or updated. For example, the factory in which a component or device is manufactured or assembled could be considered more secure than the environments in which most devices are used. There are exceptions to this, for example security minded governmental agencies may consider devices that never leave their buildings more secure than those produced remotely in a factory.

In some examples, the detecting may include collecting data relating to a characteristic of the at least one component.

A component may be detected by verifying its existence within the device. To improve the reliability of the detection, and reduce the risk of a component successfully imitating another component, data relating to the behaviour and characteristics of the component may be collected. Such data may relate to operation parameters, boot time, run time and/or power usage of the component for example.

In some examples, the method may further comprise, in response to the component being legitimate or deemed legitimate by virtue of the comparison, updating a level of trust associated with the component.

Legitimate or genuine components may still specify a level of trust to be set or changed depending on how secure that component is expected to be. For example, security standards exist and are associated with different levels of trust. Based on those standards, a component may have a corresponding assigned level of trust.

In some examples, there is provided a computer-readable medium. The computer-readable medium may store instructions which, when executed on a computer, cause the computer to carry out a process. The process may correspond to the method described above. In some examples, the process may comprise detecting a state of a computing device. The computing device may comprise at least one component. The method may further comprise comparing the detected state with a certified state of the device. The certified state may indicate a state of the device as certified by a trusted authority. In response to the detected state and the certified state being different, the method may further comprise identifying a component as a source of the difference and checking, by the trusted authority, whether the component is legitimate or not. In response to the component being legitimate or deemed legitimate, the method may further comprise certifying the difference and updating the certified state.

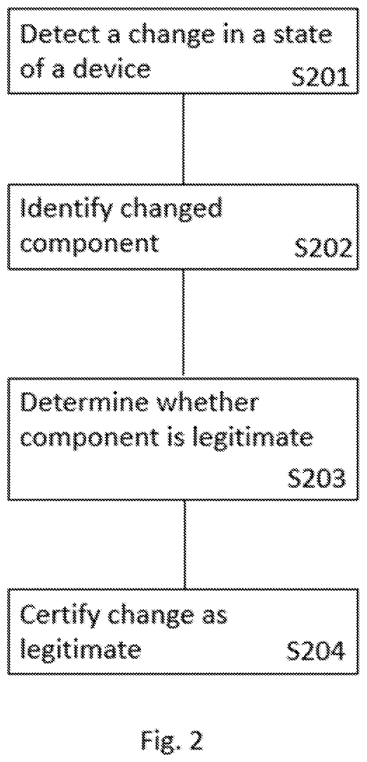

In some examples, there is provided a method as shown in FIG. 2. The method may comprise detecting S201 a change in a state of a device. The device may comprise at least one component. The method may further comprise identifying S202 at least one component that has been changed. The change may be relative to a previous state of the device or a certified state, certified by a trusted authority. The method may further comprise determining S203, by the trusted authority, whether the component is legitimate or not. In response to the component being determined to be legitimate, the method may further comprise certifying S204 the change as a legitimate change.

A state change may be detected by identifying consequential changes, resulting from the state change. For example, a component within a device may be replaced, which may cause a difference in the energy usage of the device as a whole or a difference in processing power or other behavioural differences. These differences may be detected either instantly or during a scheduled scan.

In some examples, there is provided a computer-readable medium. The computer-readable medium may store instructions which, when executed on a computer, cause the computer to carry out a process. The process may correspond to the method described above. In some examples, the process may comprise detecting a change in a state of a device. The device may comprise at least one component. The method may further comprise identifying at least one component that has been changed. The method may further comprise determining, by a trusted authority, whether the component is legitimate or not. In response to the component being determined to be legitimate, the method may comprise certifying the change as a legitimate change.

In some examples, in response to the component being legitimate, the method may comprise updating a level of trust associated with the component. In some examples, in response to the component being legitimate, the method may comprise updating rights associated with the component.

The at least one component within the device may be assigned rights based on a level of trust or performance, as well as other factors in order to ensure that the rights given to that component are appropriate for the trust and/or capabilities of the component.

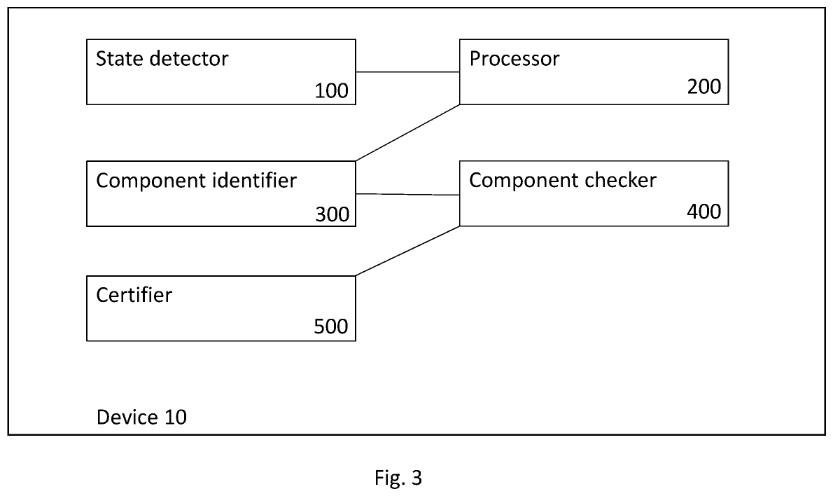

In some examples, there is provided a device 10 as shown in FIG. 3. The device 10 may comprise a state detector 100. The state detector 100 may detect a state of a computing device. The computing device may comprise at least one component. The device 10 may further comprise a processor 200. The processor 200 may compare the detected state with a certified state of the computing device. The certified state indicating a state of the computing device as certified by a trusted authority. The device 10 may further comprise a component identifier 300. The component identifier 300 may, in response to the detected state and the certified state being different, identify a component as a source of the difference. The device 10 may further comprise a component checker 400. The component checker 400 may check whether the component is authorised or not. The device 10 may further comprise a certifier 500. The certifier 500 may, in response to the component being authorised, certify the difference and update the certified state.

In accordance with some examples, the state detector 100 may be a hardware device, for example a computer processor, and/or may be a trusted device, having a similar level of trust to the trusted authority. In some examples, the state detector 100 may be a general or specific purpose computer on which programming is executable to carry out the functions of the state detector 100 described above. The state detector 100 may have access to and/or be in communication with all components on the device 10 in order to detect and determine their respective states. In accordance with some examples, the processor 200 may be a hardware device, for example a computer processor, and/or may be a comparer or comparator able to compare different states relating to a device 10. In some examples, the processor 200 may be a general or specific purpose computer on which programming is executable to carry out the functions of the processor 200 described above. In accordance with some examples, the component identifier 300 may be a hardware device, for example a computer processor, and/or may be able to access information relating to a component, such as a component identification number or another form of identification for the component. In some examples, the component identifier 300 may be a general or specific purpose computer on which programming is executable to carry out the functions of the component identifier 300 described above. In accordance with some examples, the component checker 400 may be a hardware device, for example a computer processor, and/or may be able to access information indicating whether a component is authorised or not. Such information may be stored locally, in a memory, or remotely. In some examples, the component checker 400 may be a general or specific purpose computer on which programming is executable to carry out the functions of the component checker 400 described above. In accordance with some examples, the certifier 500 may be a hardware device, for example a computer processor, and/or may be able to issue certification indicating that a changed component or the change itself is legitimate. Legitimacy may include that the change was expected, or that the replacement component is acceptable according to a predetermined policy, or meets certain performance requirements, for example. In some examples, the certifier 500 may be a general or specific purpose computer on which programming is executable to carry out the functions of the certifier 500 described above.

The device 10 may be part of the computing device or may be separate to the computing device. In some examples, the trusted authority may be local or part of the device, or the trusted authority may be remote. In an example, the device may have a local trusted authority, which may defer some assessment or certification to a remote authority.

Thus, according to some examples, there is provided a method, computer-readable medium and device for assessing individual components that have been changed and either certifying them as legitimate replacement components or taking remedial action if they are not legitimate, based on the standards/tests/policies applied. In some examples, the new certification of the change may provide an indication that the changes are accepted as legitimate, yet may not be deemed to be as trustworthy as with a factory certification and therefore, the component may be given a reduced trust or security rating.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart.

It shall be understood that each flow and/or block in the flow charts and/or block diagrams, as well as combinations of the flows and/or diagrams in the flow charts and/or block diagrams may be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
detecting a state of a computing device, the computing device comprising at least one component;
comparing the detected state with a certified state of the device, the certified state indicating an expected state of the device as certified by a trusted authority;
in response to the detected state and the certified state being different, identifying a component as a source of the difference and checking, by the trusted authority, whether the component is legitimate or not; and
in response to the component being legitimate, certifying the difference and updating the certified state.

2. The method of claim 1, wherein
the certified state includes a device component list indicating the at least one component and a profile relating to the at least one component.

3. The method of claim 2, wherein
the profile includes data relating to operation parameters, boot time, run time and/or power usage of the component.

4. The method of claim 2, wherein
the profile is created by the trusted authority based on a measured or detected characteristic of the component.

5. The method of claim 1, wherein
the detecting includes collecting data relating to a characteristic of the at least one component.

6. The method of claim 1, the method further comprising:
in response to the component being legitimate, updating a level of trust associated with the component.

7. The method of claim 1, the method further comprising:
in response to the component not being legitimate, isolating the component.

8. A computer-readable medium storing instructions which, when executed on a computer, cause the computer to carry out a process comprising:
detecting a change in a state of a device, the device comprising at least one component;
identifying at least one component that has been changed;
determining, by a trusted authority, whether the component is legitimate or not; and
in response to the component being determined to be legitimate, certifying the change as a legitimate change.

9. The computer-readable medium of claim 8, wherein the process further comprises:
in response to the component being legitimate, updating a level of trust associated with the component.

10. The computer-readable medium of claim 8, wherein the process further comprises:
in response to the component being legitimate, updating rights associated with the component.

11. A device comprising:
a state detector to detect a state of a computing device, the computing device comprising at least one component;
a processor to compare the detected state with a certified state of the device, the certified state indicating a state of the device as certified by a trusted authority;
a component identifier to, in response to the detected state and the certified state being different, identify a component as a source of the difference;
a component checker to check whether the component is authorised or not; and
a certifier to, in response to the component being authorised, certify the difference and update the certified state.

12. The device of claim 11, wherein
the trusted authority is located within the device; or
the trusted authority is located remotely from the device.

13. The device of claim 11, wherein
the state detector is further to carry out challenge-response-type actions when detecting the state of a computing device.

14. The device of claim 11, wherein
in response to the component not being authorised, the component checker is to isolate the component.

15. The device of claim 11, wherein
the certified state includes a device component list indicating the at least one component and a profile relating to the at least one component.
